(19) United States
(12) Patent Application Publication
(10) Pub. No.: US 2004/0103580 A1
(43) Pub. Date: Jun. 3, 2004

(54) Weed-preventing paper for use in plant cultivation

(75) Inventors: Rui-Zhi Huang, Taoyuan (TW); Chun-Chi Chou, Sin-Shih Township (TW)

Correspondence Address: Haverstock & Owens LLP, 162 North Wolfe Road, Sunnyvale, CA, 94086, US

(73) Assignee: Yuen Foong Yu Bio-Tech Co. Ltd.

(21) Appl. No.: 10/719,378

(22) Filed: Nov. 21, 2003

(30) Foreign Application Priority Data
Nov. 26, 2002 (TW) 091134376

(51) Int. Cl. A01G 7/00

(52) U.S. Cl. 47/9

(57) ABSTRACT

A weed-preventing paper with multiple functions for use in plant cultivation is provided. The weed-preventing paper includes a paper body covering a surface of a soil where the plant is to be grown, and having at least a cross opening for the plant to pass therethrough, a weed-preventing agent contained in the paper body for blocking light so as to prevent the growth of a weed surrounding the plant, and a water indicator printed on the paper body and showing a hydrous and an anhydrous states thereof via different colors for being a reminder of watering.

### FIELD OF THE INVENTION

The present invention relates to a weed-preventing paper for cultivating a plant, and more particularly to a multi-functional weed-preventing paper with a cross opening for a plant to pass therethrough, a control-release fertilizer, a beautifying figure and a water indicator.

### BACKGROUND OF THE INVENTION

The horticultural crops include flowers, fruiters, garden vegetable and special crops and so on. There are many problems causing from weeds during the cultivating period. Because the growing period for the perennial fruiter is very long, the competitions between fruiters and weeds mostly occur at any time. Most parts of the cultivating area locate on the mountainside and the cultivating area is usually very wide. Thus, the weed control has become more and more difficult. The farmers usually remove the weeds under canopy area for conveniently applying the fertilizer to the soil and proceeding the further productive management. One of the common ways for proceeding the weed control is to use the herbicides. As we know, the chemical reagents are harmful to both the environment and the people. And, some crops are sensitive to certain reagents so that we can't use the chemical reagents to proceed the weed control sometimes. As a result, a number of manpower are needed to remove the weeds by hand. However, the step of hand weeding is the most time-consuming process, which always delays the agricultural production for a period of time and increases the production costs.

Recently, the quality life is gradually improved and thus home gardening has become more and more popular for beautifying the environment and enhancing the life interest. However, there also exist weed control problems and watering management for the plant growth. These always bother the owners of the pot plants. It will easily cause the plant diseases if the soil is too wet. On the contrary, the plant would wither when the soil is too dry. Hence, it is a big concern for the plant owner about how to water the pot plant at suitable time.

From the above description, it is known that how to develop a method for satisfying the requirements of weed removal and providing a good water management has become a major problem waited to be solved. In order to satisfy the needs described above, a weed-preventing paper for cultivating a plant is provided. The particular design in the present invention uses a paper not only containing a weed-preventing agent for preventing the weed growth, but also including a water indicator for reminding the plant owner to water the plant. It is very convenient and easy for use, and therefore the man-power and production costs are greatly reduced. Thus, the invention has the utility for the agricultural industry and home gardening.

Therefore, the present invention provides a weed-preventing paper for cultivating a plant which overcomes the disadvantages described above.

Another aspect, character and executive adduction of the present invention will become more completely comprehensible by the following revelation and accompanying claim.

### SUMMARY OF THE INVENTION

It is an object of the present invention to provide a multi-purpose agricultural paper having the features of biodegrading and strong light-blocking ability so that it can be used as functional basic materials to control weeds, indicator to water plants, and supply fertilizer, and most of all, it saves manpower.

It is therefore an object of the present invention to provide a weed-preventing paper for use in plant cultivation for effectively preventing the weed growth.

It is another object of the present invention to provide a weed-preventing paper for use in plant cultivation. The weed-preventing paper has specific cross openings for a plant conveniently to pass therethrough.

It is another object of the present invention to provide a weed-preventing paper for use in plant cultivation. The weed-preventing paper with the design of watering indication could provide the function of reminding the owner of the pot plant to water the pot plant timely.

In accordance with an aspect of the present invention, the weed-preventing paper for cultivating a plant includes a paper body covering a surface of a soil where the plant is to be grown and having at least a cross opening for the plant to pass therethrough, a weed-preventing agent contained in the paper body for blocking light so as to prevent the growth of a weed surrounding the plant, and a water indicator printed on the paper body and showing a hydrous and an anhydrous states thereof via different colors for being a reminder of watering.

Preferably, the cross opening has a lateral crosscut extending to an edge of the paper body for facilitating the paper body to be mounted around a stem of the plant.

Preferably, the water indicator contains a cobaltous chloride (CoCl₂).

Preferably, the water indicator is printed on the paper in a shape of a word or a figure.

Preferably, the weed-preventing paper further includes a control-release fertilizer to be dissolvable in water to provide nutrients for the growth of the plant and reduce the manpower cost of fertilizing.

Preferably, the control-release fertilizer is integrated into the paper body by adding in a pulp thereof, or coated thereon or adhered thereto.

Preferably, the weed-preventing paper further includes a beautifying figure printed on the paper body.

Preferably, the beautifying figure is an image selected from a group consisting of a flower, a grass, a person and a scenery.

Preferably, a surface of the paper body has a silver color for preventing bugs.

Preferably, the weed-preventing paper is applied to one of a potted plant and a fruit tree.

Preferably, the paper body is circular.

Preferably, the paper body has a diameter equal to that of one of a pot where the potted plant is grown therein and an under-canopy area of the fruit tree.

Preferably, the weed-preventing agent is one of inorganic and organic fillers being one selected from a group consisting of a black carbon, a silicon dioxide and a titanium dioxide.

Preferably, the paper body is made of a biodegradable fiber.

Preferably, the fiber is one of a plant fiber and a polymer fiber.

In accordance with an aspect of the present invention, the weed-preventing paper for cultivating a plant includes a paper body covering a surface of a soil where the plant is to be grown and having at least a cross opening for the plant to pass therethrough, and a weed-preventing agent contained in the paper body for blocking light so as to prevent the growth of a weed surrounding the plant.

Preferably, the weed-preventing paper further includes a water indicator as a reminder of watering.

Preferably, the water indicator contains a cobaltous chloride (CoCl₂).

Preferably, the water indicator is printed on the paper in a shape of a word or a figure.

Preferably, the weed-preventing paper further includes a control-release fertilizer to be dissolvable in water to provide nutrients for the growth of the plant and reduce the manpower cost of fertilizing.

Preferably, the weed-preventing agent is one of inorganic and organic fillers being one selected from a group consisting of a black carbon, a silicon dioxide and a titanium dioxide.

Preferably, the paper body is made of a biodegradable fiber.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIGS. 1(a) and 1(b) are the schematic diagrams showing the weed-preventing paper with a cross opening according to a preferred embodiment of the present invention.

FIGS. 2(a) and 2(b) are the schematic diagrams showing the weed-preventing paper with a water indicator according to a preferred embodiment of the present invention, wherein FIG. 2(a) is the weed-preventing paper before watering and FIG. 2(b) is the weed-preventing paper after watering.

FIG. 3 shows the practical application of the watering indication design according to a preferred embodiment of the present invention.

FIG. 4 is the schematic diagram showing the weed-preventing paper according to a preferred embodiment of the present invention.

FIGS. 5(a) and 5(b) are the schematic diagrams showing the weed-preventing paper according to a preferred embodiment of the present invention.

The foregoing and other features and advantages of the present invention will be more clearly understood through the following descriptions with reference to the drawings, wherein:

### DETAILED DESCRIPTION OF THE PREFERRED EMBODIMENT

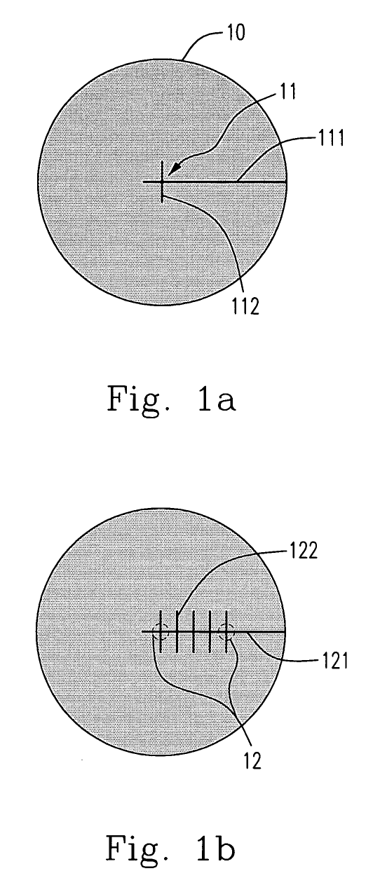

Please refer to FIG. 1a which is the schematic diagram showing the weed-preventing paper with a cross opening according to a preferred embodiment of the present invention. The weed-preventing paper includes a paper body 10 which is composed of a biodegradable material, such as plant fibers or polymer fibers. Thus, the weed-preventing paper has the advantage of being decomposed in natural environment easily and does not result in environmental pollution. Moreover, the paper body 10 includes a weed-preventing agent for preventing the weed growth. The weed-preventing agent can be an inorganic or organic filler including black carbon, silicon dioxide or titanium dioxide. The light is blocked out up to 100% by the paper body 10 containing a weed-preventing agent. Thus, the weeds die resulting from the weed seeds being incapable of germinating or the weed seedlings being incapable of carrying out photosynthesis under dark condition so that the weed growth surrounding the plant is inhibited efficiently.

The weed-preventing paper according to the present invention could be applied to a pot plant. The weed-preventing paper is cut into round shape having a diameter equal to that of the pot so as to fit the pot size, and a cross opening 11 is formed at the central portion of the paper. The cross opening 11 consists of a long cutting opening 111 and a short cutting opening 112 vertical to the long one. The long cutting opening 111 extends from the central portion to an edge of the paper body 10. A plant can pass through the cross opening 11 which facilitates the paper body 10 to be mounted around the stem of the plant. Therefore, the weed control is achieved by covering the soil surface of the pot with the weed-preventing paper of the present invention.

Please refer to FIG. 1b which is the schematic diagram showing the weed-preventing paper with a cross opening according to a preferred embodiment of the present invention. Because the deviation of the planting position of the pot plant might occur due to man-made planting or natural growing, the position of the pot plant is not always positioned in the central portion of the pot. That is, the weed-preventing paper is applied to the pot plant planted in the central portion of the pot for passing therethrough only if a cross opening is formed at the central portion thereof. In order to overcome this defect, the design of the weed-preventing paper according to a preferred embodiment of the present invention is that an opening is cut from the center to the edge of the paper to be a basic cutting opening 121 and a plurality of cutting openings 122 with suitable lengths are cut vertically thereto so as to form multiple cross openings 12 on the weed-preventing paper. Hence, the weed-preventing paper could be used for properly covering the soil surface no matter where the plant is planted.

Besides, the present invention also has the design of watering indication for assisting the owner of the pot plant to do the water management in order to timely water the pot plant. The design of watering indication is to use a water indicator printed on the paper body, which shows a hydrous and an anhydrous states via different colors for being a reminder of watering. One of the water indicators suitable for use in the present invention is cobaltous chloride (CoCl₂). Cobaltous chloride is a crystalline compound whose anhydrous form consists of blue crystals, and whose hydrous form consists of pink crystals. That is to say the color of cobaltous chloride is blue while it is dry, and is pink while it absorbs water to contain crystal water.

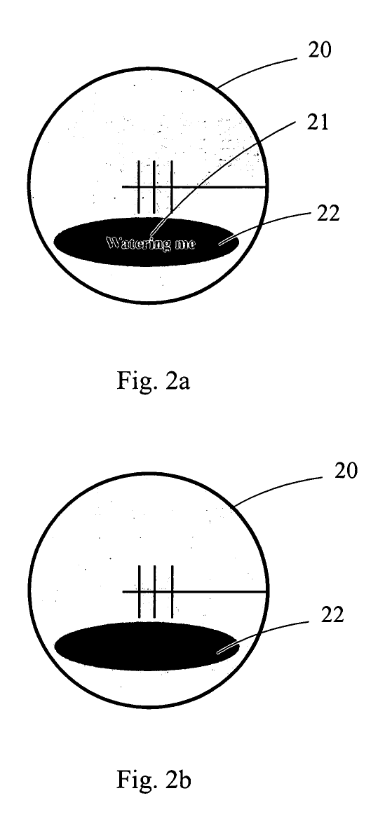

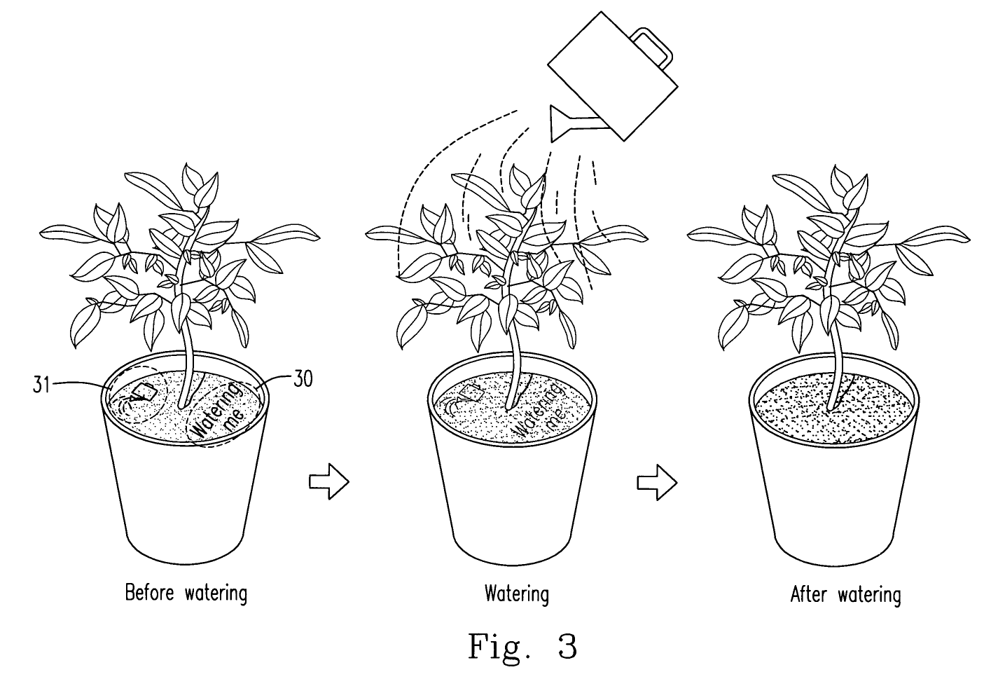

Please refer to FIGS. 2a and 2b which show the weed-preventing paper with a water indicator according to a preferred embodiment of the present invention. According to a preferred embodiment of the present invention, cobaltous chloride is printed on the paper body 20 of the weed-preventing paper in the form of reminding words 21 (as shown in FIG. 2a) or FIG. 31 (as shown in FIG. 3). The reminding words 21 could be the words, for example, “Watering Me” and “Give me some water” and so on. The weed-preventing paper is attached close to the soil surface of the pot. While the weed-preventing paper is in a dry manner due to the soil lacks of water, CoCl₂ printed thereon does not contain crystal water and thus becomes blue (as shown in FIG. 2a). On the contrary, the weed-preventing paper will absorb water while the soil is wet after watering, and consequently the CoCl₂ will also absorb water to contain crystal water and thus become pink. Therefore, the background 22 of the reminding words 21 (as shown in FIG. 2a) could be printed with a pink color. In such a way, the reminding words 21 show the blue color when the soil is dry, which reveals the big difference compared with the background 22 with pink color so as to produce the effect for reminding the plant owner to water the plant. However, the reminding words 21 reveal pink color while the soil is wet, that is the same as that of the background 22 to let those words or figures hidden (as shown in FIG. 2b).

Please refer to FIG. 3 which shows the implementation of the watering reminding design of the weed-preventing paper according the present invention. There is no need to limit the color of the background of the weed-preventing paper to be pink because the color of CoCl₂ is almost colorless at low concentration (<0.6 M). Referring to FIG. 3, it could be seen that the printed reminding words 30 or FIG. 31 could be clearly presented for reminding the plant owner to water the plant when the soil of the pot plant is dry. After the pot plant is watered, the color of the reminding words 30 or FIG. 31 is nearly colorless, which shows the effect of hiding the reminding words 30 or FIG. 31. From the description described above, the weed-preventing paper of the present invention has the function of reminding the pot plant owner to water the pot plant via the water indicator while the soil of the pot plant is too dry. Besides, the pot plant owner could be aware of the water content in the soil of the pot plant and decide whether to water the pot plant or not to avoid improper water management for the pot plant, which leads to lead to the death of the plant.

According to a preferred embodiment of the present invention, the weed-preventing paper further includes a control-release fertilizer which is an organic or chemical fertilizer (such as the “MAGAMP” in the market). The control-release fertilizer can dissolve in water slowly. The nutrients are released in the water and then provided to the pot plant for growth requirement so as to reduce the manpower of manually fertilization. The control-release fertilizer is integrated into the paper body by being mixed with the pulp, or coated on or adhered to the paper body.

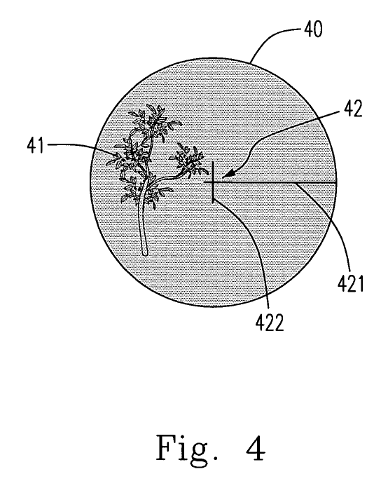

Please refer to FIG. 4 which shows the weed-preventing paper according to a preferred embodiment of the present invention. According to the preferred embodiment of the present invention, the weed-preventing paper further includes a beautifying FIG. 41 printed on the paper body 40 for beautifying the soil surface of the pot plant, such as an image of a flower, a grass, a person or a scenery. A silver color could also be printed on a surface of the paper body 40 for producing the effect of preventing bugs as a silver plastic sheet does.

Additionally, the weed-preventing paper could also be applied to the weed control under canopy area of the fruit three. Please refer to FIG. 4 again. The paper body 40 of the weed-preventing paper for use in the fruit tree is made of waste paper sludge and the control-release fertilizer for fruit tree is added thereto. The weight of the paper body 40 of the weed-preventing paper is increased to avoid the paper body 40 from being blown in the wind and thus the weed-preventing paper is well attached to the soil surface of the under-canopy area of the fruit tree. The paper body 40 is cut into a circular shape with a diameter equal to that of the under-canopy area of the fruit tree. A cross opening 42 is formed at the central portion of the paper body 40, so that the stem of the fruit tree can pass therethrough easily. The cross opening 42 has a long cutting opening 421 cut from the central to the edge of the paper body 40 and at least one short cutting opening 422 vertical to the long one. The cross opening 42 is used for facilitating the paper body 40 to be mounted around the stem of the fruit tree so that the weed-preventing paper covers the soil surface of the under-canopy area of the fruit tree for preventing the weeds and managing the fertilization. A beautifying FIG. 41 for beautifying the soil surface of the under-canopy area of the fruit tree is printed on the paper body 40 too, for example, an image of a flower, a grass, a person or a scenery and so on. Since the fruits are often ate or plucked by the animal, a figure with deterrent use (such as an image of an eagle etc.) can be printed on the paper body 40 for frightening animals away. Also, the beautifying FIG. 41 can make the soil surface look pleasant after fertilization treatment.

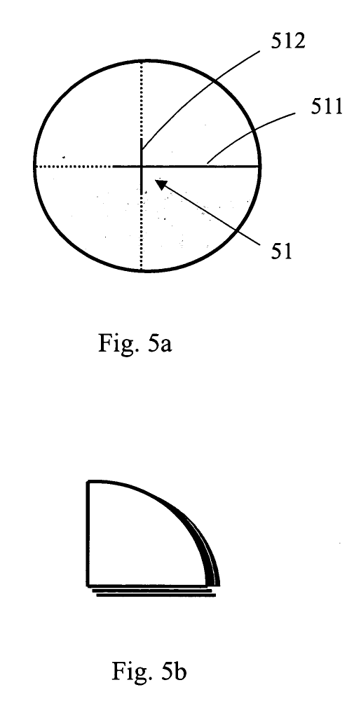

Please refer to FIGS. 5a and 5b which are the schematic diagrams showing the weed-preventing paper for the under-canopy area of fruit tree according to a preferred embodiment of the present invention. As shown in FIG. 5a, the weed-preventing paper has a circular shape and a cross opening 51. The cross opening 51 has a long cutting opening 511, a short cutting opening 512 vertical to the long one, and pre-folded folds (the dotted lines in FIG. 5b). The pre-folded folds of the weed-preventing paper are formed by folding up the paper based on the long cutting opening 511 and then folding up the paper again. The weed-preventing paper with folded form is shown in FIG. 5(b). The folded weed-preventing paper can be conveniently stored, transited, carried and operated.

The weed preventing test using the weed-preventing paper of the present invention is as follows. A 7-inch-diameter pot filled with proper amount of growing media (soil: peat moss=3:1, v/v) is provided and a coreopsis (Corepsis tinctoria Nutt.) seedling is transplanted thereto. Then, the seedling is passed through the opening of the weed-preventing paper and thus the soil surface is covered by the paper. After the foregoing steps, the pot plant is moved to the outdoors for further cultivation. A pot plant without the covering of weed-preventing paper is the control. Each treatment is set in six repetitions. The weed growth is observed and recorded during the cultivation. The results are shown in Table 1

TABLE 1

| | Average weed No. (plant) | | | | | | |
|---|---|---|---|---|---|---|---|
| | Cultivating week(s) | | | | | | |
| Treatment | 1 | 2 | 3 | 4 | 8 | 12 | 24 |
| weed-preventing paper | 0.0 | 0.0 | 0.0 | 0.0 | 0.0 | 0.8 | 0.8 |
| Control | 23.3 | 48.2 | 53.8 | 54.8 | 51.2 | 43.0 | 40.5 |

As shown in Table 1, the average weed number for the treatment of pot-cultured coreopsis covered with weed-preventing paper is 2.5 after 24 weeks cultivation and that of the control is 40.5. There are significantly different weed numbers between these two treatments after same cultivation periods. Therefore, it is an effective method to prevent the weed growth by using the weed-preventing paper of the present invention.

According to the above, it is clear that the weed-preventing paper for use in plant cultivation of the present invention has the feature of being capable of effectively preventing the weed growth. The weed-preventing paper has multiple cross openings for passing a plant therethrough, a silver color for preventing bugs, the control-release fertilizer for saving the manpower cost, the beautifying image for beautifying the soil surface and a water indicator for reminding the plant owner to do the water management and so on. A certain combination of the features described above could be made depending on the user's needs. In addition, all the related materials in the present invention are biodegradable and capable of being decomposed, which is not limited by the soil environment and enables the achievement of the permanent operation in agricultural production. Therefore, the present invention has the features of industrial application and high commercial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A weed-preventing paper for cultivating a plant, comprising:
a paper body covering a surface of a soil where said plant is to be grown, and having at least a cross opening for said plant to pass therethrough;
a weed-preventing agent contained in said paper body for blocking light so as to prevent the growth of a weed surrounding said plant; and
a water indicator printed on said paper body and showing a hydrous and an anhydrous states thereof via different colors for being a reminder of watering.

2. The weed-preventing paper according to claim 1 wherein said cross opening has a lateral crosscut extending to an edge of said paper body for facilitating said paper body to be mounted around a stem of said plant.

3. The weed-preventing paper according to claim 1 wherein said water indicator contains a cobaltous chloride (CoCl₂).

4. The weed-preventing paper according to claim 1 wherein said water indicator is printed on said paper in a shape of a word or a figure.

5. The weed-preventing paper according to claim 1 further comprising a control-release fertilizer to be dissolvable in water to provide nutrients for the growth of said plant and reduce the manpower cost of fertilizing.

6. The weed-preventing paper according to claim 5 wherein said control-release fertilizer is integrated into said paper body by adding in a pulp thereof, or coated thereon or adhered thereto.

7. The weed-preventing paper according to claim 1 further comprising a beautifying figure printed on said paper body.

8. The weed-preventing paper according to claim 7 wherein said beautifying figure is an image selected from a group consisting of a flower, a grass, a person and a scenery.

9. The weed-preventing paper according to claim 1 wherein a surface of said paper body has a silver color for preventing bugs.

10. The weed-preventing paper according to claim 1 wherein said weed-preventing paper is applied to one of a potted plant and a fruit tree.

11. The weed-preventing paper according to claim 10 wherein said paper body is circular.

12. The weed-preventing paper according to claim 11 wherein said paper body has a diameter equal to that of one of a pot where said potted plant is grown therein and an under-canopy area of said fruit tree.

13. The weed-preventing paper according to claim 1 wherein said weed-preventing agent is one of inorganic and organic fillers being one selected from a group consisting of a black carbon, a silicon dioxide and a titanium dioxide.

14. The weed-preventing paper according to claim 1 wherein said paper body is made of a biodegradable fiber.

15. The weed-preventing paper according to claim 14 wherein said fiber is one of a plant fiber and a polymer fiber.

16. A weed-preventing paper for cultivating a plant, comprising:
a paper body covering a surface of a soil where said plant is to be grown, and having at least a cross opening for said plant to pass therethrough; and
a weed-preventing agent contained in said paper body for blocking light so as to prevent the growth of a weed surrounding said plant.

17. The weed-preventing paper according to claim 16 further comprising a water indicator as a reminder of watering.

18. The weed-preventing paper according to claim 17 wherein said water indicator contains a cobaltous chloride (CoCl₂)

19. The weed-preventing paper according to claim 17 wherein said water indicator is printed on said paper in a shape of a word or a figure.

20. The weed-preventing paper according to claim 16 further comprising a control-release fertilizer to be dissolvable in water to provide nutrients for the growth of said plant and reduce the manpower cost of fertilizing.

21. The weed-preventing paper according to claim 16 wherein said weed-preventing agent is one of inorganic and organic fillers being one selected from a group consisting of a black carbon, a silicon dioxide and a titanium dioxide.

22. The weed-preventing paper according to claim 16 wherein said paper body is made of a biodegradable fiber.
